(19) United States
(12) Patent Application Publication
(10) Pub. No.: US 2009/0239147 A1
(43) Pub. Date: Sep. 24, 2009

(54) POLYMER COMPOSITION, PASTE FOR USE IN ELECTRODE FOR SECONDARY BATTERY, AND ELECTRODE FOR SECONDARY BATTERY

(75) Inventors: Kazuaki Itou, Tokyo (JP); Takeshi Mogi, Tokyo (JP); Hirobumi Suzuki, Tokyo (JP); Akira Nishikawa, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: JSR CORPORATION, Chuo-ku (JP)

(21) Appl. No.: 12/278,095

(22) PCT Filed: Feb. 2, 2007
(86) PCT No.: PCT/JP2007/051821

§ 371 Date: Oct. 21, 2008

(30) Foreign Application Priority Data
Feb. 2, 2006 (JP) 2006-026047

(51) Int. Cl. H01M 4/62; C08L 27/16; H01B 1/12

(52) U.S. Cl. 429/217; 525/199; 252/500

(57) ABSTRACT

A polymer composition comprising (a) a fluorine-containing polymer and (b) a functional group-containing polymer which contains a structural unit originating from an alkyl (meth)acrylate and a structural unit originating from at least one monomer selected from the group consisting of a sulfonic acid group-containing unsaturated monomer, an amide group-containing unsaturated monomer, and a sulfonic acid group and amide group-containing unsaturated monomer is provided.

### TECHNICAL FIELD

The present invention relates to a polymer composition suitable as a binder for a secondary battery electrode, a paste for a secondary battery electrode, and a secondary battery electrode.

### BACKGROUND ART

In recent years, due to remarkable downsizing and weight saving of electric devices, a strong demand has developed for miniaturization and lightening in weight of batteries which serve as a power source for electric devices. In order to satisfy this demand, various secondary batteries have been developed. For example, a nickel hydrogen secondary battery, a lithium ion secondary battery, and the like have been put into practical use.

As a method for producing the electrode used as a component of these secondary batteries, a method of mixing and dispersing an active material and a fluororesin such as polytetrafluoroethylene or polyvinylidene fluoride, which is used as a binder, in an organic solvent such as N-methylpyrrolidone (NMP) used as a dispersion medium, to obtain a paste and applying and drying the paste on a power collector is generally used.

The binder has a function of increasing adhesion to the power collector of an electrode layer containing an active material. However, the fluororesin such as polytetrafluoroethylene and polyvinylidene fluoride does not necessarily have sufficient adhesion to the collector. A secondary battery made from an electrode in which adhesion of the electrode layer and the collector is insufficient cannot improve the battery performance such as charge-and-discharge cycle characteristics.

As a related prior art, a method of using a hydrogenated diene polymer modified by introducing a functional group such as a carboxyl group as a binder for a lithium secondary battery has been disclosed (for example, refer to Patent Document 1). However, the effect of increasing the adhesion of the electrode layer and the collector is not necessarily sufficient even if the binder disclosed in Patent Document 1 is used. In a secondary battery equipped with an electrode with insufficient adhesion, a capacity decrease at high-speed electric discharge and by repeated charge-and-discharge (cycle characteristics) is remarkable.

As a material for improving the capacity decrease at high-speed discharge and by repeated charge-and-discharge (cycle characteristics), an aqueous dispersion of a polymer complex made from a fluorine-containing polymer and an acrylic polymer having a functional group such as a carboxyl group has been disclosed (for example, refer to Patent Document 2). The electrode paste prepared using an aqueous dispersion of the polymer complex disclosed in Patent Document 2, however, may easily produce a precipitate when stored for a long time and is still to be improved in adhesion to a collector. The effect of improving the capacity decrease problem has not always been satisfactory.

### (Patent Document 1) JP-A-10-17714

### (Patent Document 2) Japanese Patent 3601250

### DISCLOSURE OF THE INVENTION

The present invention has been completed in view of the above problems in general technologies and has an object of providing a polymer composition with good adhesion to collectors which can produce a secondary battery exhibiting only a small capacity decrease during high-speed electric discharge and excellent cycle characteristics, a paste for secondary battery electrodes, and a secondary battery electrode in which adhesion of an electrode layer and a collector is excellent and which can produce a secondary battery exhibiting only a small capacity decrease during high-speed electric discharge and excellent cycle characteristics.

The inventors of the present invention have conducted extensive studies in order to achieve the above object. As a result, the inventors have found that the above object can be achieved by a composition comprising a fluorine-containing polymer and a functional group-containing polymer which contains a structural unit originating from at least one monomer selected from the group consisting of a sulfonic acid group-containing unsaturated monomer, an amide group-containing unsaturated monomer, and a sulfonic acid group and amide group-containing unsaturated monomer. Thus, the present invention has been completed.

Specifically, the following polymer compositions, pastes for secondary battery electrodes, and secondary battery electrodes are provided according to the present invention.

[1] A polymer composition comprising (a) a fluorine-containing polymer and (b) a functional group-containing polymer which contains a structural unit originating from an alkyl (meth)acrylate and a structural unit originating from at least one monomer selected from the group consisting of a sulfonic acid group-containing unsaturated monomer, an amide group-containing unsaturated monomer, and a sulfonic acid group and amide group-containing unsaturated monomer.
[2] The polymer composition according to [1], wherein the fluorine-containing polymer (a) and the functional group-containing polymer (b) combine to form a polymer complex.
[3] The polymer composition according to [1] or [2], obtained by emulsion polymerization of the fluorine-containing polymer (a) as a seed polymer, and the alkyl (meth)acrylate and at least one monomer selected from the group consisting of the sulfonic acid group-containing unsaturated monomer, the amide group-containing unsaturated monomer, and the sulfonic acid group and amide group-containing unsaturated monomer.
[4] The polymer composition according to any one of [1] to [3], wherein the fluorine-containing polymer (a) comprises (a-1) 50 to 80 mass % of a structural unit originating from vinylidene fluoride, (a-2) 20 to 50 mass % of a structural unit originating from hexafluoropropylene, and (a-3) 0 to 30 mass % of a structural unit originating from other unsaturated monomers.
[5] The polymer composition according to any one of [1] to [4], wherein the functional group-containing polymer (b) comprises (b-1) 40 to 80 mass % of a structural unit originating from an alkyl (meth)acrylate, (b-2) 0.1 to 20 mass % of a structural unit originating from a sulfonic acid group-containing unsaturated monomer, and (b-5) 0 to 40 mass % of a structural unit originating from other unsaturated monomers.
[6] The polymer composition according to any one of [1] to [4], wherein the functional group-containing polymer (b) comprises (b-1) 40 to 80 mass % of a structural unit originating from an alkyl (meth)acrylate, (b-3) 0.1 to 30 mass % of a structural unit originating from an amide group-containing unsaturated monomer, and (b-5) 0 to 30 mass % of a structural unit originating from other unsaturated monomers.
[7] The polymer composition according to any one of [1] to [4], wherein the functional group-containing polymer (b) comprises (b-1) 40 to 80 mass % of a structural unit originating from an alkyl (meth)acrylate, (b-2) 0 to 15 mass % of a structural unit originating from a sulfonic acid group-containing unsaturated monomer, (b-3) 0 to 30 mass % of a structural unit originating from an amide group-containing unsaturated monomer, with a proviso that (b-2)+(b-3)=0.1 mass % or more, and (b-5) 0 to 30 mass % of a structural unit originating from other unsaturated monomers.
[8] The polymer composition according to any one of [1] to [4], wherein the functional group-containing polymer (b) comprises (b-1) 40 to 80 mass % of a structural unit originating from an alkyl (meth)acrylate, (b-4) 0.1 to 20 mass % of a structural unit originating from a sulfonic acid group and amide group-containing unsaturated monomer, and (b-5) 0 to 30 mass % of a structural unit originating from other unsaturated monomers.
[9] The polymer composition according to any one of [1] to [5] and [7], wherein the sulfonic acid group-containing unsaturated monomer is at least one monomer selected from the group consisting of styrene sulfonic acid, methacryloxybenzene sulfonic acid, allyloxybenzene sulfonic acid, allyl sulfonic acid, vinyl sulfonic acid, methacryl sulfonic acid, 4-sulfobutylmethacrylate, and isoprene sulfonic acid, and salts of these sulfonic acids.
[10] The polymer composition according to any one of [1] to [4] and [8], wherein the sulfonic acid group and amide group-containing unsaturated monomer is 2-acrylamide-2-methylpropane sulfonic acid.
[11] The polymer composition according to any one of [1] to [10], further comprising (c) an organic solvent.
[12] The polymer composition according to any one of [1] to [11] used as a binder for a secondary battery electrode.
[13] A paste for a secondary battery electrode comprising the polymer composition according to any one of [1] to [12] and an electrode active material.
[14] The paste for a secondary battery electrode according to [13] comprising 0.1 to 10 parts by mass (solid content) of the polymer composition per 100 parts by mass of the electrode active material.
[15] A secondary battery electrode comprising a power collector and an electrode layer formed on the surface of the power collector by applying and drying the paste for secondary battery electrode according to [13] or [14].

The polymer composition of the present invention can produce a secondary battery which exhibits only a small capacity decrease during high-speed discharge, excellent cycle characteristics, and excellent adhesion to a power collector.

The paste for a secondary battery of the present invention can produce a secondary battery which exhibits only a small capacity decrease during high-speed discharge, excellent cycle characteristics, and excellent adhesion to a power collector.

The secondary battery electrode of the present invention can produce a secondary battery which exhibits only a small capacity decrease during high-speed discharge and excellent cycle characteristics, and ensures excellent adhesion of the electrode layer and a power collector.

### BEST MODE FOR CARRYING OUT THE INVENTION

Preferred embodiments of the present invention are described below. Note that the present invention is not limited to the following embodiments. Various modifications and improvements may be made on the embodiments without departing from the scope of the present invention based on the knowledge of a person skilled in the art.

### 1. Polymer Composition

The polymer composition in one embodiment of the present invention comprises (a) a fluorine-containing polymer (hereinafter referred to also as “component (a)”) and (b) a functional group-containing polymer which contains a structural unit originating from an alkyl (meth)acrylate and a structural unit originating from at least one monomer selected from the group consisting of a sulfonic acid group-containing unsaturated monomer, an amide group-containing unsaturated monomer, and a sulfonic acid group and amide group-containing unsaturated monomer (hereinafter referred to also as “component (b)”). The details are described below.

### ((a) Fluorine-Containing Polymer)

The component (a) included in the polymer composition of the embodiment is a fluorine-containing polymer. Although there are no specific limitations to the component (a) insofar as the component (a) is a fluorine-containing polymer, a polymer obtained by polymerizing a monomer component containing (a-1) vinylidene fluoride and (a-2) hexafluoropropylene can be given as a preferable example.

The monomer component used for obtaining the component (a) may include (a-3) other unsaturated monomers in addition to the vinylidene fluoride (a-1) and hexafluoropropylene (a-2). As examples of the other unsaturated monomers (a-3), alkyl (meth)acrylates such as methyl (meth)acrylate, ethyl (meth)acrylate, n-propyl (meth)acrylate, i-propyl (meth)acrylate, n-butyl (meth)acrylate, i-butyl (meth)acrylate, n-amyl (meth)acrylate, i-amyl (meth)acrylate, n-hexyl (meth)acrylate, 2-ethylhexyl (meth)acrylate, n-octyl (meth)acrylate, n-nonyl (meth)acrylate, n-decyl (meth)acrylate, ethylene glycol di(meth)acrylate, propylene glycol di(meth)acrylate, trimethylolpropane tri(meth)acrylate, pentaerythritol tetra(meth)acrylate, and dipentaerythritol hexa(meth)acrylate; aromatic vinyl compounds such as styrene, α-methylstyrene, and divinylbenzene; vinyl esters such as vinyl acetate and vinyl propionate; halogenated vinyl compounds such as vinyl fluoride, tetrafluoroethylene, vinyl chloride, and vinylidene chloride; conjugation dienes such as butadiene, isoprene, and chloroprene; ethylene; and unsaturated monomers having a specific functional group can be given. These unsaturated monomers may be used either individually or in combination of two or more.

As examples of the functional group in the above-mentioned unsaturated monomers having a specific functional group, a carboxyl group, a carboxylic anhydride group, an amide group, an amino group, a cyano group, an epoxy group, a vinyl group, and a sulfonic acid group can be given. Of these, a carboxyl group, an amide group, an epoxy group, a cyano group, and a sulfonic acid group are preferable.

As examples of the carboxyl group-containing unsaturated monomers, unsaturated monocarboxylic acids such as acrylic acid, methacrylic acid, and crotonic acid; unsaturated polycarboxylic acids such as maleic acid, fumaric acid, itaconic acid, citraconic acid, and mesaconic acid; and free carboxyl group-containing alkyl esters or free carboxyl group-containing amides of the unsaturated polycarboxylic acid can be given.

As examples of the carboxylic anhydride group-containing unsaturated monomers, acid anhydrides of the above-mentioned unsaturated polycarboxylic acids can be given.

Examples of the amide group-containing unsaturated monomers include unsaturated carboxylic acid amides such as (meth)acrylamide, α-chroloacrylamide, N,N′-methylene (meth)acrylamide, N,N′-ethylene (meth)acrylamide, N-hydroxymethyl (meth)acrylamide, N-2-hydroxyethyl (meth)acrylamide, N-2-hydroxypropyl (meth)acrylamide, N-3-hydroxypropyl (meth)acrylamide, crotonic acid amide, maleic acid diamide, fumaric acid diamide, and diacetone acrylamide; and N-aminoalkyl derivatives of an unsaturated carboxylic acid amide such as N-dimethylaminomethyl (meth)acrylamide, N-2-aminoethyl (meth)acrylamide, N-2-methylaminoethyl (meth)acrylamide, N-2-ethylaminoethyl (meth)acrylamide, N-2-dimethylaminoethyl (meth)acrylamide, N-2-diethylaminoethyl (meth)acrylamide, N-3-aminopropyl (meth)acrylamide, N-3-methylaminopropyl (meth)acrylamide, and N-3-dimethylaminopropyl (meth)acrylamide.

Examples of the amino group-containing unsaturated monomers include aminoalkyl esters of an unsaturated carboxylic acid such as 2-aminomethyl (meth)acrylate, 2-methylaminomethyl (meth)acrylate, 2-dimethylaminomethyl (meth)acrylate, 2-aminoethyl (meth)acrylate, 2-methylaminoethyl (meth)acrylate, 2-ethylaminoethyl (meth)acrylate, 2-dimethylaminoethyl (meth)acrylate, 2-diethylaminoethyl (meth)acrylate, 2-n-propylaminoethyl (meth)acrylate, 2-n-butylaminoethyl (meth)acrylate, 2-aminopropyl (meth)acrylate, 2-methylaminopropyl (meth)acrylate, 2-dimethylaminopropyl (meth)acrylate, 3-aminopropyl (meth)acrylate, 3-methylaminopropyl (meth)acrylate, and 3-dimethylaminopropyl (meth)acrylate; N-aminoalkyl derivatives of an unsaturated carboxylic acid amide such as N-dimethylaminomethyl (meth)acrylamide, N-2-aminoethyl (meth)acrylamide, N-2-methylaminoethyl (meth)acrylamide, N-2-ethylaminoethyl (meth)acrylamide, N-2-dimethylaminoethyl (meth)acrylamide, N-2-diethylaminoethyl (meth)acrylamide, N-3-aminopropyl (meth)acrylamide, N-3-methylaminopropyl (meth)acrylamide, and N-3-dimethylaminopropyl (meth)acrylamide.

As examples of the cyano group-containing unsaturated monomers, unsaturated carboxylic acid nitriles such as (meth)acrylonitrile, α-chroloacrylonitrile, and cyanated vinyliden, and cyanoalkyl esters of unsaturated carboxylic acid such as 2-cyanoethyl (meth)acrylate, 2-cyanopropyl (meth)acrylate, and 3-cyanopropyl (meth)acrylate can be given.

As examples of the epoxy group-containing unsaturated monomers, unsaturated group-containing glycidyl compounds such as glycidyl (meth)acrylate and (meth)allylglycidyl ether can be given.

As examples of the sulfonic acid group-containing unsaturated monomers, 2-acrylamide-2-methylpropane sulfonic acid, styrene sulfonic acid (salt), isoprene sulfonic acid (salt), and the like can be given.

The content of the structural unit originating from vinylidene fluoride (a-1) contained in the component (a) is preferably 50 to 80 mass %, more preferably 55 to 80 mass %, and even more preferably 60 to 80 mass %. If the content of the structural unit originating from the vinylidene fluoride (a-1) is less than 50 mass %, the resulting polymer composition tends to easily exhibit layer separation due to deterioration of compatibility particularly with the structural unit originating from alkyl (meth)acrylate. A content of more than 80 mass % causes difficulty in seed polymerization of the structural unit originating from alkyl (meth)acrylate and the structural unit originating from sulfonic acid group-containing unsaturated monomers using the fluorine-containing polymer as a seed polymer, which reduces compatibility between the fluorine-containing polymer and the sulfonic acid group-containing polymer. As a result, the resulting polymer composition tends to easily exhibit layer separation.

The content of the structural unit originating from hexafluoropropylene (a-2) contained in the component (a) is preferably 20 to 50 mass %, more preferably 20 to 45 mass %, and particularly preferably 20 to 40 mass %. A content of less than 20 mass % causes difficulty in seed polymerization of the structural unit originating from alkyl (meth)acrylate and the structural unit originating from sulfonic acid group-containing unsaturated monomers using the fluorine-containing polymer as a seed polymer, which reduces compatibility between the fluorine-containing polymer and the sulfonic acid group-containing polymer. In addition, the resulting polymer composition tends to easily exhibit layer separation. If the content of the structural unit originating from the hexafluoropropylene (a-2) is more than 50 mass %, the resulting polymer composition tends to easily exhibit layer separation caused by reduced compatibility between the fluorine-containing polymer and the sulfonic acid group-containing polymer due to impaired compatibility particularly with the structural unit originating from alkyl (meth)acrylate.

The content of the structural unit originating from the other unsaturated monomers (a-3) contained in the component (a) is preferably 0 to 30 mass %, more preferably 0 to 25 mass %, and particularly preferably 0 to 20 mass %. If the content of the structural unit originating from the other unsaturated monomers (a-3) is more than 30 mass %, the resulting polymer composition tends to easily exhibit layer separation caused by reduced compatibility between the fluorine-containing polymer and the sulfonic acid group-containing polymer.

### ((b) Functional Group-Containing Polymer)

The component (b) contained in the polymer composition according to the embodiment is a functional group-containing polymer. The component (b) is obtained by polymerizing a monomer component containing at least one monomer selected from the group consisting of (b-1) alkyl (meth)acrylate, (b-2) sulfonic acid group-containing unsaturated monomer, (b-3) amide group-containing unsaturated monomer, and (b-4) sulfonic acid group and amide group-containing unsaturated monomer. The term “sulfonic acid group and amide group-containing unsaturated monomer” refers to a compound (monomer) containing both the sulfonic acid group and the amide group in one molecule.

As examples of the alkyl (meth)acrylate (b-1), methyl (meth)acrylate, ethyl (meth)acrylate, n-propyl (meth)acrylate, i-propyl (meth)acrylate, n-butyl (meth)acrylate, i-butyl (meth)acrylate, n-amyl (meth)acrylate, i-amyl (meth)acrylate, n-hexyl (meth)acrylate, 2-ethylhexyl (meth)acrylate, n-octyl (meth)acrylate, n-nonyl (meth)acrylate, n-decyl (meth)acrylate, ethylene glycol di(meth)acrylate, propylene glycol di(meth)acrylate, trimethylolpropane tri(meth)acrylate, pentaerythritol tetra(meth)acrylate, dipentaerythritol hexa(meth)acrylate, and the like can be given.

As examples of the sulfonic acid group-containing unsaturated monomers (b-2), styrene sulfonic acid, methallyloxybenzene sulfonic acid, allyloxybenzene sulfonic acid, allyl sulfonic acid, vinyl sulfonic acid, methallyl sulfonic acid, 4-sulfobutyl methacrylate, isoprene sulfonic acid, and the salt of these compounds can be given. 2-Acrylamide-2-methylpropane sulfonic acid, styrene sulfonic acid, allyloxybenzene sulfonic acid, and the salt of these compounds are preferable. These sulfonic acid group-containing unsaturated monomers can be used individually or in combination of two or more.

Examples of the amide group-containing unsaturated monomers (b-3) include unsaturated carboxylic acid amides such as (meth)acrylamide, α-chroloacrylamide, N,N′-methylene (meth)acrylamide, N,N′-ethylene (meth)acrylamide, N-hydroxymethyl (meth)acrylamide, N-2-hydroxyethyl (meth)acrylamide, N-2-hydroxypropyl (meth)acrylamide, N-3-hydroxypropyl (meth)acrylamide, crotonic acid amide, maleic acid diamide, fumaric acid diamide, and diacetone acrylamide; and N-aminoalkyl derivatives of unsaturated carboxylic acid amide such as N-dimethylaminomethyl (meth)acrylamide, N-2-aminoethyl (meth)acrylamide, N-2-methylamino ethyl (meth)acrylamide, N-2-ethylaminoethyl (meth)acrylamide, N-2-dimethylaminoethyl (meth)acrylamide, N-2-diethylaminoethyl (meth)acrylamide, N-3-aminopropyl (meth)acrylamide, N-3-methylaminopropyl (meth)acrylamide, and N-3-dimethylaminopropyl (meth)acrylamide. These amide group-containing unsaturated monomers can be used individually or in combination of two or more.

As examples of the sulfonic acid group and amide group-containing unsaturated monomers (b-4), 2-acrylamide-2-methylpropane sulfonic acid and the like can be given.

The monomer component used for obtaining the component (b) may contain (b-5) other unsaturated monomers, in addition to the alkyl (meth)acrylate (b-1), the sulfonic acid group-containing unsaturated monomer (b-2), the amide group-containing unsaturated monomer (b-3), and the sulfonic acid group and amide group-containing unsaturated monomer (b-4). As examples of the other unsaturated monomers (b-5), aromatic vinyl compounds, vinyl esters, halogenated vinyl compounds, conjugation dienes, and ethylene which are previously mentioned as examples of the other unsaturated monomer (a-3), can be given.

The content of the structural unit originating from the alkyl (meth)acrylate (b-1) contained in the component (b) is preferably 40 to 80 mass %, more preferably 45 to 80 mass %, and particularly preferably 50 to 80 mass %. If the content of the structural unit originating from the alkyl (meth)acrylate (b-1) is less than 40 mass %, the resulting polymer composition tends to easily exhibit layer separation due to insufficient compatibility between the fluorine-containing polymer and the sulfonic acid group-containing polymer. If the amount is more than 80 mass %, the volume tends to excessively expand in the slurry for electrodes.

If the component (b) is a polymer containing the structural unit originating from the alkyl (meth)acrylate (b-1), the structural unit originating from the sulfonic acid group-containing unsaturated monomer (b-2), and the structural unit originating from the other unsaturated monomers (b-5) (hereinafter referred to also as “sulfonic acid group-containing polymer”), the content of the structural unit originating from the sulfonic acid group-containing unsaturated monomer (b-2) is preferably 0.1 to 20 mass %, more preferably 0.1 to 18 mass %, and particularly preferably 0.1 to 16 mass %. If the content of the structural unit originating from the sulfonic acid group-containing unsaturated monomer (b-2) is less than 0.1 mass %, a good aqueous dispersion may not be obtained due to insufficient chemical stability of particles during polymerization in aqueous dispersion media. If the content is more than 20 mass %, viscosity tends to become too high during polymerization in aqueous media, causing particle agglomeration. In addition, a good aqueous dispersion may not be obtained.

When the component (b) is the sulfonic acid group-containing polymer, the content of the structural unit originating from the other unsaturated monomers (b-5) contained in the sulfonic acid group-containing polymer is preferably 0 to 40 mass %, more preferably 0 to 30 mass %, and particularly preferably 0 to 20 mass %. If the content of the structural unit originating from the other unsaturated monomers (b-5) is more than 40 mass %, the resulting polymer composition tends to easily exhibit layer separation due to insufficient compatibility between the fluorine-containing polymer and the sulfonic acid group-containing polymer.

If the component (b) is a polymer containing the structural unit originating from the alkyl (meth)acrylate (b-1), the structural unit originating from the amide group-containing unsaturated monomer (b-3), and the structural unit originating from the other unsaturated monomers (b-5) (hereinafter referred to also as “amide group-containing polymer”), the content of the structural unit originating from the amide group-containing unsaturated monomer (b-3) is preferably 0.1 to 30 mass %, more preferably 0.1 to 25 mass %, and particularly preferably 0.1 to 20 mass %. If the content of the structural unit originating from the amide group-containing unsaturated monomer (b-3) is less than 0.1 mass %, a good aqueous dispersion may not be obtained due to insufficient chemical stability of particles during polymerization in aqueous dispersion media. If the content is more than 30 mass %, viscosity tends to become too high during polymerization in aqueous media causing particle agglomeration, and a good aqueous dispersion may not be obtained.

When the component (b) is the amide group-containing polymer, the content of the structural unit originating from the other unsaturated monomers (b-5) contained in the amide group-containing polymer is preferably 0 to 30 mass %, more preferably 0 to 25 mass %, and particularly preferably 0 to 20 mass %. If the content of the structural unit originating from the other unsaturated monomers (b-5) is more than 30 mass %, the resulting polymer composition tends to easily exhibit layer separation due to insufficient compatibility between the fluorine-containing polymer and the amide group-containing polymer.

If the component (b) is a polymer containing the structural unit originating from the alkyl (meth)acrylate (b-1), the structural unit originating from the sulfonic acid group-containing unsaturated monomer (b-2), the structural unit originating from the amide group-containing unsaturated monomer (b-3), and the structural unit originating from the other unsaturated monomers (b-5) (hereinafter referred to also as “first sulfonic acid group and amide group-containing polymer”), the content of the structural unit originating from the sulfonic acid group-containing monomer (b-2) contained in the first sulfonic acid group and amide group-containing polymer is preferably 0 to 15 mass %, and more preferably 0 to 10 mass %. The content of the structural unit originating from the amide group-containing unsaturated monomers (b-3) contained in the first sulfonic acid group and amide group-containing polymer is preferably 0 to 30 mass %, more preferably 0.1 to 25 mass %, and particularly preferably 0.1 to 20 mass %.

If the content of the structural unit originating from the sulfonic acid group-containing unsaturated monomer (b-2) is more than 15 mass % or the content of the structural unit originating from the amide group-containing unsaturated monomer (b-3) is more than 30 mass %, viscosity tends to become too high during polymerization in aqueous media causing particle agglomeration. In addition, a good aqueous dispersion may not be obtained.

When the component (b) is the first sulfonic acid group and amide group-containing polymer, the content of the structural unit originating from the other unsaturated monomers (b-5) contained in the first sulfonic acid group and amide group-containing polymer is preferably 0 to 30 mass %, more preferably 0 to 25 mass %, and particularly preferably 0 to 20 mass %. If the content of the structural unit originating from the other unsaturated monomers (b-5) is more than 30 mass %, the resulting polymer composition tends to easily exhibit layer separation due to insufficient compatibility between the fluorine-containing polymer and the functional group-containing polymer.

The content of the structural unit originating from the sulfonic acid group-containing unsaturated monomer (b-2) and the structural unit originating from the amide group-containing unsaturated monomers (b-3) contained in the first sulfonic acid group and amide group-containing polymer ((b-2)+(b-3)) is preferably 0.1 mass % or more, more preferably 0.2 mass % or more, and particularly preferably 0.4 mass % or more. If (b-2)+(b-3) is less than 0.1 mass %, a good aqueous dispersion may not be obtained due to insufficient chemical stability of particles during polymerization in aqueous media.

If the component (b) is a polymer containing the structural unit originating from the alkyl (meth)acrylate (b-1), the structural unit originating from the sulfonic acid group and amide group-containing unsaturated monomer (b-4), and the structural unit originating from the other unsaturated monomers (b-5) (hereinafter referred to also as “second sulfonic acid group and amide group-containing polymer”), the content of the structural unit originating from the sulfonic acid group and amide group-containing unsaturated monomer (b-4) contained in the second sulfonic acid group and amide group-containing polymer is preferably 0.1 to 20 mass %, more preferably 0.1 to 18 mass %, and particularly preferably 0.1 to 15 mass %. If the content of the structural unit originating from the sulfonic acid group and amide group-containing unsaturated monomer (b-4) is less than 0.1 mass %, a good aqueous dispersion may not be obtained due to insufficient chemical stability of particles during polymerization in aqueous media. If the content is more than 20 mass %, viscosity tends to become too high during polymerization in aqueous media causing particle agglomeration. In addition, a good aqueous dispersion may not be obtained.

When the component (b) is the second sulfonic acid group and amide group-containing polymer, the content of the structural unit originating from the other unsaturated monomers (b-5) contained in the second sulfonic acid group and amide group-containing polymer is preferably 0 to 30 mass %, more preferably 0 to 25 mass %, and particularly preferably 0 to 20 mass %. If the content of the structural unit originating from the other unsaturated monomers (b-5) is more than 30 mass %, the resulting polymer composition tends to easily exhibit layer separation due to insufficient compatibility between the fluorine-containing polymer and the functional group-containing polymer.

### (Polymer Complex)

The polymer composition according to the embodiment preferably forms a polymer complex of the component (a) and the component (b) in order to produce a secondary battery which exhibits only a small capacity decrease during high-speed discharge, excellent cycle characteristics, and excellent adhesion to a power collector. A toluene-insoluble component contained in the polymer complex is usually 20 to 100 mass %, and preferably 30 to 90 mass %. If the toluene-insoluble component contained in the polymer complex is less than 20 mass %, polymer flow occurs during drying after application when the binder for electrodes prepared using the polymer composition containing the polymer complex is used. As a result, the electrode active materials tend to be excessively coated, which may result in a decrease in conductivity of the electrode and may cause overvoltage. In addition, durability in electrolytes easily decreases, causing the electrode active materials to easily fall away from the power collector.

Melting point (Tm) of the polymer complex is preferably 170° C. or less, and more preferably 0 to 110° C., and particularly preferably 30 to 60° C. If the melting point (Tm) of the polymer complex is more than 170° C., flexibility and adherence become low, allowing only a small amount of the electrode active materials to adhere to the power collector.

### (Preparation of Polymer Complex)

The polymer complex may be prepared preferably by emulsion polymerization. Specifically, after obtaining the component (a) by emulsion polymerization, emulsion polymerization of alkyl (meth)acrylate and the component containing the sulfonic acid group-containing unsaturated monomer may be carried out using the component (a) as a seed polymer.

### (Amount of Component (a) and Component (b))

The amount of the component (a) is preferably 3 to 60 parts by mass, and more preferably 10 to 50 parts by mass for the total amount of the component (a) and the component (b) of 100 parts. If the amount of the component (a) is less than 3 parts by mass, chemical resistance tends to be poor. If the amount of the component (a) is more than 60 parts by mass, binding performance tends to become low. In addition, capacity tends to decrease and cycle characteristics tend to deteriorate during high-speed electric discharge.

### ((c) Organic Solvent)

It is preferable that the polymer composition according to the embodiment further comprise (c) organic solvent (hereinafter referred to also as “component (c)”). Boling point (bp) of the component (c) at one atmosphere is preferably 100° C. or more, more preferably 115° C. or more, and particularly preferably 130° C. or more. As specific examples of the component (c), toluene, N-methylpyrrolidone (NMP), methyl isobutyl ketone (MIBK), cyclohexanone, dimethyl sulfoxide (DMSO), dimethyl formamide (DMF), and the like can be given. Among these, NMP, DMSO, and DMF are preferable.

When the component (a) and the component (b) combine to form the polymer complex, the polymer complex is preferably dissolved or dispersed in the component (c). When the polymer complex is dispersed in the component (c), the number average particle diameter of the particles of the polymer complex is preferably 0.02 to 2 μm, more preferably 0.05 to 1.8 μm, and particularly preferably 0.1 to 1.5 μm. The term “number average particle diameter” refers to the value measured by the dynamic light scattering method.

### (Preparation of Polymer Composition)

The polymer composition according to the embodiment may be prepared by the following method. First, an aqueous dispersion containing the component (a) and the component (b) are mixed with the component (c) to obtain a mixed raw material composition. Then, water is removed from the mixed raw material composition to obtain a polymer composition according to the embodiment, containing an organic solvent.

The polymer composition according to the embodiment may be prepared also by the following method. First, water is removed from an aqueous dispersion of the component (a) and an aqueous dispersion of the component (b) which are prepared by a general method. Water may be removed after mixing the component (a) and the component (b). The component (c) may be added, as required, to the component (a) and the component (b) after removing water to obtain the polymer composition according to the embodiment. Although not particularly limited, water may be removed by evaporation, ultrafiltration, fractional filtration, phase conversion of dispersion medium, and the like.

The amount of water contained in the polymer composition according to the embodiment is preferably 2.0 mass % or less, more preferably 1.5 mass % or less, and particularly preferably 1.0 mass % or less. A water content exceeding 2.0 mass % may adversely affect the active material in the slurry, causing a decrease in battery capacity.

The polymer composition according to the embodiment may be suitably used as a binder for a secondary battery electrode, a binder for a capacitor electrode, and the like by utilizing characteristics of the composition.

### 2. Paste for Secondary Battery Electrode

Next, one embodiment of the paste for the secondary battery electrode of the present invention is described. The paste for the secondary battery electrode according to the embodiment contains the polymer composition and the electrode active material. Various additives may be added, as required, to the mixture of the polymer composition and the electrode active material to obtain the paste for the secondary battery electrode according to the embodiment.

The paste for the secondary battery electrode according to the embodiment contains the polymer composition in an amount (solid content) of preferably 0.1 to 10 parts by mass, more preferably 0.5 to 10 parts by mass, and particularly preferably 1 to 10 parts by mass for 100 parts by mass of the electrode active material. If the amount of the polymer composition is less than 0.1 part by mass, good adhesion may not be exhibited. If the amount of the polymer composition exceeds 10 parts by mass, internal resistance tends to become too large, which may adversely affect the battery performance. The polymer composition and the electrode active material may be mixed using various kneading machines, bead mills, high pressure homogenizers, and the like.

As examples of the various additives added, as required, to the paste for the secondary battery electrode according to the embodiment, a viscosity adjuster which is a polymer soluble in an organic solvent to be used, an electrical conductive material such as an electrical conductive carbon including graphite, metallic powder, and the like can be given. When the organic solvent is NMP, for example, examples of the viscosity adjuster, which is a polymer soluble in an organic solvent to be used, are ethylene vinyl alcohol, polyvinyl alcohol, polyvinyl pyrrolidone, polyacrylamide, polymethyl methacrylate, polyvinylidene fluoride, and the like.

As the electrode active material contained in the paste for the secondary battery electrode according to the embodiment, hydrogen storing alloy powder is suitable when the electrode is used in an aqueous battery such as a nickel-metal hydride battery. More specifically, a MmNi₅-based material in which some of the Ni is replaced with an element such as Mn, Al, and Co, is preferably used, wherein the “Mm” refers to mischmetal, a mixture of rare earth metals. The electrode active material is preferably a powder with a diameter of 3 to 400 μm, which passes though a 100 mesh screen. As examples of the material used for a non-aqueous battery, an inorganic compound such as MnO₂, MoO₃, V₂O₅, V₆O₁₃, Fe₂O₃, Fe₃O₄, Li₍₁₋ₓ)CoO₂, Li₍₁₋ₓ₎.NiO₂, LiₓCo_{y}Sn_{z}O₂, Li₍₁₋ₓ₎Co_{(1-y)}Ni_{y}O₂, TiS₂, TiS₃, MoS₃, FeS₂, CuF₂, and NiF₂; a carbon material such as fluorocarbon, graphite, chemical vapor deposited carbon fiber and/or powder thereof, PAN-based carbon fiber and/or powder thereof, and pitch-based carbon fiber and/or powder thereof, and an electrical conductive polymer such as polyacetylene and poly-p-phenylene can be given. Use of a lithium ion-containing composite oxide such as Li₍₁₋ₓ₎CoO₂, Li₍₁₋ₓ₎NiO₂, LiₓCo_{y}Sn_{z}O₂, and Li₍₁₋ₓ₎Co_{(1-y)}Ni_{y}O₂ is particularly preferable because a battery may be fabricated while both the positive and the negative electrodes are being discharged.

As an active material for the negative electrode, a carbon material such as fluorocarbon, graphite, chemical vapor deposited carbon fiber and/or powder thereof, PAN-based carbon fiber and/or powder thereof, and pitch-based carbon fiber and/or powder thereof, an electrical conductive polymer such as polyacetylene and poly-p-phenylene, and an amorphous compound made from tin oxide and fluorine are preferably used. Especially when graphite materials such as natural or artificial graphite with a high graphization degree or highly graphized mesophase carbon are used, a battery with excellent charge/discharge cycle characteristics and large capacity may be obtained. When a carbonaceous material is used as the active material for the negative electrode, the average particle diameter of the carbonaceous material is preferably 0.1 to 50 μm, more preferably 1 to 45 μm, and particularly preferably 3 to 40 μm, if decrease in current efficiency, decrease in paste stability, and increase of resistance between particles in the coated film on an electrode are considered.

### 3. Secondary Battery Electrode

Next, one embodiment of the secondary battery electrode of the present invention is described. The secondary battery according to the embodiment comprises a power collector and an electrode layer formed on the surface of the power collector by applying and drying the paste for the secondary battery electrodes.

As examples of the power collector for aqueous batteries, an Ni mesh, an Ni-plated punched metal, an expanded metal, a metallic gauze, a foam metal, a netted metal fiber sintered body, and the like can be given. As the power collector for non-aqueous batteries, aluminum foil and copper foil are preferably used. The secondary battery electrode according to the embodiment may be obtained by forming the electrode layer by applying the paste for the secondary battery electrode to at least one surface of the power collector to the specific thickness, and heating and drying the paste. The paste for the secondary battery electrode may be applied to the surface of the power collector by an arbitrary method using a coater head such as reverse roll coating, commabar system, gravure coating, and air knife coating.

The paste for the secondary battery electrode applied on the surface of the power collector may be dried by allowing the coating to stand or by using a blow drier, a hot air drier, an infrared heater, a deep infrared heater, and the like. The drying temperature is preferably 20 to 250° C., and more preferably 130 to 170° C. The drying time is preferably 1 to 120 minutes, and more preferably 5 to 60 minutes.

The secondary battery electrode according to the embodiment may be suitably used as a battery electrode for both the aqueous batteries and non-aqueous batteries. Excellent performance may be exhibited by using the electrode as a nickel-hydrogen battery cathode of an aqueous battery, or as an alkaline secondary battery cathode or a lithium-ion battery cathode of a non-aqueous battery.

When a battery is fabricated using the secondary battery electrode according to the embodiment, a non-aqueous electrolyte which is obtained by dissolving an electrolyte in a non-aqueous solvent is usually used. There are no particular limitations to the electrolyte to be used. As examples of the electrolyte for the alkaline secondary battery, LiClO₄, LiBF₄, LiAsF₆, CF₃SO₃Li, LiPF₆, LiI, LiAlCl₄, NaClO₄, NaBF₄, NaI, (n-Bu)₄NClO₄, (n-Bu)₄NBF₄, KPF₆, and the like can be given.

As examples of the solvent used for the electrolyte, ethers, ketones, lactones, nitriles, amines, amides, sulfur compounds, chlorinated hydrocarbons, esters, carbonates, nitro compounds, phosphate compounds, sulfolane compounds, and the like can be given. Of these, ethers, ketones, nitriles, chlorinated hydrocarbons, carbonates and sulfolane compounds are preferable. Specifically, tetrahydrofuran, 2-methyltetrahydrofuran, 1,4-dioxane, anisole, monoglyme, diglyme, triglyme, acetonitrile, propionitrile, 4-methyl-2-pentanone, butyronitrile, valeronitrile, benzonitrile, 1,2-dichloroethane, γ-butyrolactone, dimethoxy ethane, methyl folmate, propylene carbonate, ethylene carbonate, dimethyl formamide, dimethyl sulfoxide, dimethyl thioformamide, sulfolane, 3-methyl-sulfolane, trimethyl phosphoric acid, triethyl phosphoric acid, and a mixture of these compounds can be given. As the electrolyte for aqueous batteries, an aqueous solution of potassium hydroxide (5N or more) is usually used.

A battery may comprise various parts such as a separator, a terminal, and an insulating plate. The battery may be a paper battery in which a cathode and an anode, and, as required, a separator are made a single layer or plural layers, or a cylinder battery obtained by rolling up a cathode and an anode, and, as required, a separator. The secondary battery prepared by using the secondary battery electrode according to the embodiment may be suitably used in AV equipment, OA equipment, communication equipment, and the like.

### EXAMPLES

The present invention is described below in more detail by way of examples. Note that the present invention is not limited to the following examples. In the examples, “part(s)” means “part(s) by weight” and “%” means “wt %” unless otherwise indicated. Methods used for measuring and evaluating various properties were as follows.

[Number average particle diameter]: measured using a light scattering measuring device “ALV5000” manufactured by AVL in which a 22 mW He—Ne laser (λ=632.8 nm) was used as a light source.
[Preparation of electrode]: A coating liquid for electrodes was obtained by mixing and stirring 100 parts of Li_{1.03}Co_{0.95}Sn_{0.42}O₂ with an average particle diameter of 5 μm, 5 parts of acetylene black, and 8 parts of a binder composition in NMP. The resulting coating liquid was applied on an aluminum foil with a thickness of 50 μm in an amount of 200 g/m² and dried to obtain a cathode electrode with a total thickness of 110 μm. A lithium-ion secondary battery was fabricated using “PIOXCEL A100” (manufactured by Pionics Co., Ltd.) as an anode electrode.
[Adhesion to metallic foil]: A test piece with a width of 2 cm and a length of 10 cm was cut from the resulting battery electrode (cathode electrode). The surface of the electrode layer side of the test piece was attached to an aluminum plate using a double-stick tape. In addition, an adhesive tape with a width of 18 mm (“Cellotape” manufactured by Nichiban Co., Ltd., specified in JIS Z1522) was attached to the surface of the collector material side of the test piece. The tape was exfoliated at a rate of 50 mm/min in the 90° direction to measure the strength (g/cm). An average of five measurements was calculated and used as peel strength (g/cm). The larger the peel strength, the larger the adhesion strength between the collector and the electrode and the more difficult it is to peel the electrode layer from the collector.
[Capacity maintenance factor]: A 0.2 C constant current operation of charging up to 4 V, followed by discharging down to 3 V at 25° C. was repeated 300 times using the secondary battery produced as mentioned above. The discharge capacity (mAh/g (discharge capacity per 1 g of active material)) at the fifth cycle, and the discharge capacity (mAh/g) after operation of 100 cycles, 200 cycles, and 300 cycles were measured to determine the capacity maintenance factor after 100 cycles, 200 cycles, and 300 cycles according to the following formula.

Capacity maintenance factor (%)={(discharge capacity after predetermined cycles)/(discharge capacity at the fifth cycle)}×100 (1)

[Polymerization stability]: 100 g of the aqueous dispersion of the polymer complex was filtered sequentially using 120 mesh, 200 mesh, 300 mesh, and 500 mesh wire gauze. The condensed lumps remaining as residues on each piece of wire gauze were dried using 105° C. hot air dryer and the weight was measured to determine the amount of the condensed lumps produced. The polymerization stability was evaluated according to the following standard.
Good: When amount of the condensed lumps was less than 0.2 mass % of the total polymer (solid component) obtained.
Fair: When amount of the condensed lumps was 0.2 mass % or more, but less than 0.5 mass % of the total polymer (solid component) obtained.
Bad: When amount of the condensed lumps was 0.5 mass % or more of the total polymer (solid component) obtained.

### Example 1

An autoclave with an internal volume of about 6 liters equipped with a magnetic stirrer, of which the internal atmosphere was sufficiently replaced with nitrogen, was charged with 2.5 l of deoxidized pure water and 25 g of ammonium perfluorodecanoate as an emulsifier. The mixture was heated to 60° C. while stirring at 350 rpm. Next, the autoclave was charged with a mixed gas consisting of 44.2% of vinylidene fluoride (VDF) and 55.8% of hexafluoro propylene (HFP) until the internal pressure was increased to 20 kg/cm²G. Then, 25 g of “Freon-113 solution” which contains 20% of diisopropylperoxy dicarbonate as a polymerization initiator was pressed into the autoclave using nitrogen gas to initiate polymerization. A pressure of 20 kg/cm²G. was maintained during the polymerization by sequentially introducing a mixed gas consisting of 60.2% of VDF and 39.8% of HFP into the autoclave. Because the polymerization speed is retarded along with the progress of polymerization, the polymerization initiator of the same amount as above was introduced using nitrogen gas after three hours to continue the polymerization for a further three hours. The reaction solution was cooled and stirring was discontinued. Then, the reaction was terminated by discharging the unreacted monomers to obtain fluoropolymer latex.

A 7 l separable flask of which the internal atmosphere was sufficiently replaced with nitrogen was charged with 150 parts (on a solid basis) of the fluoropolymer latex and 3 parts of 2-(1-allyl)-4-nonylphenoxy polyethylene glycol ammonium sulfate as an emulsifier, and the mixture was heated to 75° C. Next, 60 parts of n-butyl acrylate, 36 parts of methyl methacrylate, 4 parts of sodium styrenesulfonate, and an appropriate amount of water were added, and the mixture was stirred at 75° C. for 30 minutes. Then, after the addition of 0.5 parts of sodium persulfate as a polymerization initiator, the mixture was polymerized at 85 to 95° C. for two hours. The reaction was terminated by cooling to obtain an aqueous dispersion of a polymer complex containing a fluoropolymer and a sulfonic acid group-containing polymer.

NMP in an amount of 900 parts per 100 parts (on solid basis) of the resulting aqueous dispersion was added to the aqueous dispersion. Water was removed by distillation under reduced pressure using a rotary evaporator in which the temperature was set at 85° C. to obtain a polymer composition of Example 1. The amount of residual water was measured by titration using a Karl Fischer's reagent to confirm that the water content was 0.8%. Adhesion of the polymer composition to a metallic foil was found to be “130 g/cm”. The capacity maintenance factor of the secondary battery produced using the polymer composition was 95% (after 100 cycles), 93% (after 200 cycles), and 90% (after 300 cycles).

### Examples 2 to 6

Polymer compositions of Examples 2 to 4 were obtained in the same manner as in Example 1 by using the formulations shown in Table 1. Adhesion of the polymer compositions to a metallic foil was evaluated. The results are shown in Table 1. The capacity maintenance factors of the secondary batteries produced using the polymer compositions were measured. The results are shown in Table 1. The abbreviations of monomer components (components (a) and (b)) in Table 1 are as follows.

VDF: vinylidene fluoride
HFP: hexafluoropropylene
nBA: n-butyl acrylate
NMA: methyl methacrylate
ST: styrene
AA: acrylic acid
IA: itaconic acid

### NMAM: N-methylolacrylamide

DAAM: diacetoneacrylamide
ATBS: 2-acrylamide-2-methylpropane sulfonate
NASS: sodium styrene sulfonate
GMA: glycidyl methacrylate

### Example 7

NMP in an amount of 900 parts was added to 100 parts (on solid basis) of latex of a fluoropolymer which was obtained in the same manner as in Example 1. Water was removed by distillation under reduced pressure using a rotary evaporator in which the temperature was set at 85° C. to obtain an NMP solution of the fluoropolymer.

A 7 l separable flask of which the internal atmosphere was sufficiently replaced with nitrogen was charged with 3 parts of 2-(1-allyl)-4-nonylphenoxy polyethylene glycol ammonium sulfate as an emulsifier, and the mixture was heated to 75° C. Next, 60 parts of n-butyl acrylate, 36 parts of methyl methacrylate, 4 parts of sodium styrenesulfonate, and an appropriate amount of water were added, and the mixture was stirred at 75° C. for 30 minutes. Then, after the addition of 0.5 parts of sodium persulfate as a polymerization initiator, the mixture was polymerized at 85 to 95° C. for two hours. The reaction was terminated by cooling to obtain an aqueous dispersion of a sulfonic acid group-containing polymer. NMP in an amount of 900 parts was added to 100 parts (on solid basis) of the resulting aqueous dispersion of the sulfonic acid group-containing polymer. Water was removed by distillation under reduced pressure using a rotary evaporator at a temperature of 85° C. to obtain an NMP solution of the sulfonic acid group-containing polymer.

The resulting NMP solution of the fluoropolymer and NMP solution of the sulfonic acid group-containing polymer were blended in amounts to make a polymer composition containing the fluoropolymer and the sulfonic acid group-containing polymer (Example 5) in the same proportion as in the polymer composition obtained in Example 1. The resulting polymer composition was submitted to various evaluation tests. Adhesion of the polymer compositions to a metallic foil was evaluated. The results are shown in Table 1. The capacity maintenance factor of the secondary batteries produced using the polymer composition was measured. The results are shown in Table 1.

### Comparative Example 1

Polymer composition of Comparative Example 1 was obtained in the same manner as in Example 1 by using the formulation shown in Table 1. Adhesion of the polymer compositions to a metallic foil was evaluated. The results are shown in Table 1. The capacity maintenance factors of the secondary batteries produced using the polymer compositions were measured. The results are shown in Table 1.

### Comparative Example 2

A latex of fluoropolymer was obtained in the same manner as in Example 1 by using the formulation shown in Table 1. NMP in an amount of 900 parts was added to 100 parts (on solid basis) of the resulting latex of the fluoropolymer. Water was removed by distillation under reduced pressure using a rotary evaporator at a temperature of 85° C. to obtain an NMP solution of the fluoropolymer. The amount of residual water in the NMP solution was measured by titration using a Karl Fischer's reagent to confirm that the water content was 1.3%. The resulting NMP solution was submitted to various evaluation tests. Adhesion of the NMP solution to a metallic foil was evaluated. The results are shown in Table 1. The capacity maintenance factor of the secondary batteries produced using the NMP solution was measured. The results are shown in Table 1.

### Comparative Example 3

A 7 l separable flask of which the internal atmosphere was sufficiently replaced with nitrogen was charged with 3 parts of 2-(1-allyl)-4-nonylphenoxy polyethylene glycol ammonium sulfate as an emulsifier, and the mixture was heated to 75° C. Next, 60 parts of n-butyl acrylate, 30 parts of styrene, 2 parts of acrylic acid, 1 part of itaconic acid, and an appropriate amount of water were added, and the mixture was stirred at 75° C. for 30 minutes. Then, after the addition of 0.5 parts of sodium persulfate as a polymerization initiator, the mixture was polymerized at 85 to 95° C. for two hours. The reaction was terminated by cooling to obtain an aqueous dispersion of a functional group-containing polymer. NMP in an amount of 900 parts was added to 100 parts (on solid basis) of the resulting aqueous dispersion of the functional group-containing polymer. Water was removed by distillation under reduced pressure using a rotary evaporator at a temperature of 85° C. to obtain an NMP solution of the functional group-containing polymer. The resulting NMP solution was submitted to various evaluation tests. Adhesion of the NMP solution to a metallic foil was evaluated. The results are shown in Table 1. The capacity maintenance factor of the secondary batteries produced using the NMP solution was measured. The results are shown in Table 1.

### Comparative Examples 4 to 7

A polymer composition was obtained in the same manner as in Example 1 by using the formulation shown in Table 1. Adhesion of the polymer compositions to a metallic foil was evaluated. The results are shown in Table 1. The capacity maintenance factors of the secondary batteries produced using the polymer compositions were measured. The results are shown in Table 1.

TABLE 1

| | | Example | | | | | | | Comparative Example | | | | | | |
|---|---|---|---|---|---|---|---|---|---|---|---|---|---|---|---|
| Component (part) | | 1 | 2 | 3 | 4 | 5 | 6 | 7 | 1 | 2 | 3 | 4 | 5 | 6 | 7 |
| Composition (a) | VDF | 53 | 53 | 53 | 70 | 53 | 53 | 53 | 53 | 53 | — | 70 | 70 | 53 | 53 |
| | HFP | 47 | 47 | 47 | 30 | 47 | 47 | 47 | 47 | 47 | — | 30 | 30 | 47 | 47 |
| Composition (b) | nBA | 60 | 60 | 60 | 45 | 60 | 60 | 60 | 60 | — | 67 | 65 | 60 | 60 | 50 |
| | MMA | 36 | 30 | 29.8 | 30 | 36 | 38 | 36 | 36 | — | — | — | 15 | 40 | 15 |
| | ST | — | 6 | 10 | 6 | — | — | — | — | — | 30 | 34.95 | — | — | — |
| | AA | — | — | — | — | — | — | — | 2 | — | 2 | — | — | — | — |
| | IA | — | — | — | 3 | — | — | — | 2 | — | 1 | — | — | — | — |
| | ATBS | — | 4 | — | — | — | 1.8 | — | — | — | — | — | — | — | — |
| | NMAM | — | — | — | — | 4 | — | — | | | | | | | |
| | DAAM | — | — | — | — | — | 0.2 | — | | | | | | — | 35 |
| | NASS | 4 | — | 0.2 | 15 | — | — | 4 | — | — | — | 0.05 | 25 | — | — |
| | GMA | — | — | — | 1 | — | — | — | — | — | — | — | — | — | — |
| Amount of composition (a) (part by | | 60 | 10 | 45 | 3 | 60 | 60 | 60 | 60 | 100 | 0 | 45 | 45 | 45 | 45 |
| mass)*¹ | | | | | | | | | | | | | | | |
| Adhesion to metallic foil (peel strength | | 130 | 140 | 130 | 135 | 130 | 140 | 105 | 85 | 12 | 86 | 50 | 113 | 80 | 120 |
| (g/cm)) | | | | | | | | | | | | | | | |
| Capacity | After 100 cycles | 95 | 94 | 95 | 94 | 95 | 95 | 95 | 95 | — | 76 | 68 | 66 | 70 | 72 |
| maintenance factor | After 200 cycles | 93 | 90 | 93 | 90 | 92 | 93 | 92 | 93 | — | 66 | 51 | 49 | 55 | 55 |
| (%) | After 300 cycles | 90 | 89 | 90 | 87 | 90 | 92 | 90 | 90 | — | 55 | 35 | 35 | 38 | 35 |

| | | | | | | | | | | | | | | |
|---|---|---|---|---|---|---|---|---|---|---|---|---|---|---|
| Polymerization stability | Good | Good | Good | Good | Good | Good | Good | Good | Good | Good | Bad | Bad | Bad | Bad |

*¹Amount of the composition (a) to the total 100 parts by mass of the composition (a) and the composition (b)

As shown in Table 1, as compared with Comparative Examples 1 to 7, the polymer composition of Examples 1 to 7 can produce electrodes exhibiting excellent adhesion of the collector and electrode layer and can provide secondary batteries with excellent cycle characteristics. More particularly, it can be seen that even the polymer composition of Example 5 in which a blend of a fluoropolymer and a sulfonic acid group-containing polymer is used showed sufficient effect. It can be seen that more excellent effects were obtained in Examples 1 to 4.

### INDUSTRIAL APPLICABILITY

The polymer composition of the present invention can produce a secondary battery which exhibits only a small capacity decrease during high-speed discharge and excellent cycle characteristics, and can be suitably used in AV equipment, OA equipment, communication equipment, and the like.

1. A polymer composition comprising (a) a fluorine-containing polymer and (b) a functional group-containing polymer which contains a structural unit originating from an alkyl (meth)acrylate and a structural unit originating from at least one monomer selected from the group consisting of a sulfonic acid group-containing unsaturated monomer, an amide group-containing unsaturated monomer, and a sulfonic acid group and amide group-containing unsaturated monomer.

2. The polymer composition according to claim 1, wherein the fluorine-containing polymer (a) and the functional group-containing polymer (b) combine to form a polymer complex.

3. The polymer composition according to claim 1, obtained by emulsion polymerization of the fluorine-containing polymer (a) as a seed polymer, and the alkyl (meth)acrylate and at least one monomer selected from the group consisting of the sulfonic acid group-containing unsaturated monomer, the amide group-containing unsaturated monomer, and the sulfonic acid group and amide group-containing unsaturated monomer.

4. The polymer composition according to claim 1, wherein the fluorine-containing polymer (a) comprises (a-1) 50 to 80 mass % of a structural unit originating from vinylidene fluoride, (a-2) 20 to 50 mass % of a structural unit originating from hexafluoropropylene, and (a-3) 0 to 30 mass % of a structural unit originating from other unsaturated monomers.

5. The polymer composition according to claim 1, wherein the functional group-containing polymer (b) comprises (b-1) 40 to 80 mass % of a structural unit originating from an alkyl (meth)acrylate, (b-2) 0.1 to 20 mass % of a structural unit originating from a sulfonic acid group-containing unsaturated monomer, and (b-5) 0 to 40 mass % of a structural unit originating from other unsaturated monomers.

6. The polymer composition according to claim 1, wherein the functional group-containing polymer (b) comprises (b-1) 40 to 80 mass % of a structural unit originating from an alkyl (meth)acrylate, (b-3) 0.1 to 30 mass % of a structural unit originating from an amide group-containing unsaturated monomer, and (b-5) 0 to 30 mass % of a structural unit originating from other unsaturated monomers.

7. The polymer composition according to claim 1, wherein the functional group-containing polymer (b) comprises (b-1) 40 to 80 mass % of a structural unit originating from an alkyl (meth)acrylate, (b-2) 0 to 15 mass % of a structural unit originating from a sulfonic acid group-containing unsaturated monomer, (b-3) 0 to 30 mass % of a structural unit originating from an amide group-containing unsaturated monomer, with a proviso that (b-2)+(b-3)=0.1 mass % or more, and (b-5) 0 to 30 mass % of a structural unit originating from other unsaturated monomers.

8. The polymer composition according to claim 1, wherein the functional group-containing polymer (b) comprises (b-1) 40 to 80 mass % of a structural unit originating from an alkyl (meth)acrylate, (b-4) 0.1 to 20 mass % of a structural unit originating from a sulfonic acid group and amide group-containing unsaturated monomer, and (b-5) 0 to 30 mass % of a structural unit originating from other unsaturated monomers.

9. The polymer composition according to claim 1, wherein the sulfonic acid group-containing unsaturated monomer is at least one monomer selected from the group consisting of styrene sulfonic acid, methacryloxybenzene sulfonic acid, allyloxybenzene sulfonic acid, allyl sulfonic acid, vinyl sulfonic acid, methacryl sulfonic acid, 4-sulfobutylmethacrylate, and isoprene sulfonic acid, and salts of these sulfonic acids.

10. The polymer composition according to claim 1, wherein the sulfonic acid group and amide group-containing unsaturated monomer is 2-acrylamide-2-methylpropane sulfonic acid.

11. The polymer composition according to claim 1, further comprising (c) an organic solvent.

12. The polymer composition according to claim 1 used as a binder for a secondary battery electrode.

13. A paste for a secondary battery electrode comprising the polymer composition according to claim 1 and an electrode active material.

14. The paste for a secondary battery electrode according to claim 13 comprising 0.1 to 10 parts by mass (solid content) of the polymer composition per 100 parts by mass of the electrode active material.

15. A secondary battery electrode comprising a power collector and an electrode layer formed on the surface of the power collector by applying and drying the paste for a secondary battery electrode according to claim 13.
